(19) United States
(12) Patent Application Publication
(10) Pub. No.: US 2016/0033129 A1
(43) Pub. Date: Feb. 4, 2016

(54) ADDITIVE MANUFACTURED GAS TURBINE ENGINE COMBUSTOR LINER PANEL

(71) Applicant: UNITED TECHNOLOGIES CORPORATION, Hartford, CT (US)

(72) Inventor: Steven W. Burd, Cheshire, CT (US)

(21) Appl. No.: 14/775,290

(22) PCT Filed: Mar. 14, 2014
(86) PCT No.: PCT/US14/28064

§ 371 Date: Sep. 11, 2015

Related U.S. Application Data
(60) Provisional application No. 61/783,464, filed on Mar. 14, 2013.

(51) Int. Cl. F23R 3/00; B23P 15/00; F02C 7/18

(52) U.S. Cl. CPC F23R 3/002; F23R 3/005; F02C 7/18; B23P 15/00; F05D 2230/30; F05D 2240/35; F05D 2260/234; F05D 2260/221

(57) ABSTRACT

A combustor of a gas turbine engine includes an additively manufactured liner panel with a heat transfer augmentation feature.

This application claims priority to U.S. Patent Appln. No. 61/783,464 filed Mar. 14, 2013.

### BACKGROUND

The present disclosure relates to a gas turbine engine and, more particularly, to a combustor section therefor.

Gas turbine engines, such as those that power modern commercial and military aircraft, generally include a compressor section to pressurize an airflow, a combustor section to burn a hydrocarbon fuel in the presence of the pressurized air, and a turbine section to extract energy from the resultant combustion gases.

Combustors are subject to high thermal loads for prolonged time periods. Historically, combustors have implemented various cooling arrangements to cool the combustor liner assemblies. Among these is a double-walled assembly approach where liner panels directly adjacent to the combustion gases are cooled via impingement on the backside and film cooled on the gas side to maintain temperatures within material limits.

Given the harsh thermal and operating environment, liner panels are constructed of high-temperature alloys, e.g. nickel, cobalt, in the form of investment castings or elaborate sheet metal fabrications. The temperatures in the combustor often may exceed the temperature of the base metal so liner panels accommodate cooling holes through the hot exposed surface of the liner panel. These are small and angled to provide effective film cooling. The outer wall of the combustor or shell may also include impingement cooling holes that introduce cooling air jets onto a back surface of the liner panels.

To still further increase cooling effectiveness, surface augmentation on the back surface in the form of very small features such as pins, cylinders, pyramids and/or rectangular geometries may also be provided. These features offer an effective area increase for heat transfer.

Conventional methods to manufacture these features requires either complex micro-machining methods; castings with wax injected pins which may restrict feature dimensions; and chemical or other etching methods that may limit the practical feature size and height-width aspect ratio.

### SUMMARY

A combustor of a gas turbine engine according to one disclosed non-limiting embodiment of the present disclosure includes an additively manufactured liner panel.

A further embodiment of the present disclosure includes a heat transfer augmentation feature.

In a further embodiment of any of the foregoing embodiments of the present disclosure, the heat transfer augmentation feature is a ramp.

In a further embodiment of any of the foregoing embodiments of the present disclosure, the heat transfer augmentation feature is rectilinear.

In a further embodiment of any of the foregoing embodiments of the present disclosure, the heat transfer augmentation feature is arcuate.

In a further embodiment of any of the foregoing embodiments of the present disclosure, the heat transfer augmentation feature is a pin.

In a further embodiment of any of the foregoing embodiments of the present disclosure the additively manufactured liner panel includes at least one hole.

In a further embodiment of any of the foregoing embodiments of the present disclosure, the at least one hole is a cooling hole.

In a further embodiment of any of the foregoing embodiments of the present disclosure, he at least one hole is a film cooling hole.

In a further embodiment of any of the foregoing embodiments of the present disclosure, the at least one cooling hole is a dilution hole.

A combustor of a gas turbine engine according to another disclosed non-limiting embodiment of the present disclosure includes a liner panel with one or more heat transfer augmentation features, the liner panel having a strength greater than about seventy percent (70%) that of its wrought material.

In a further embodiment of any of the foregoing embodiments of the present disclosure, the liner panel is additive manufactured.

A further embodiment of any of the foregoing embodiments of the present disclosure includes a plurality of studs which extend from a cold side of the additively manufactured liner panel.

In a further embodiment of any of the foregoing embodiments of the present disclosure, the additively manufactured liner panel includes at least one hole.

A method of manufacturing a liner panel of a combustor of a gas turbine engine according to another disclosed non-limiting embodiment of the present disclosure includes additively manufacturing a liner panel with a heat transfer augmentation feature.

A further embodiment of any of the foregoing embodiments of the present disclosure includes integrally manufacturing a hole through the liner panel.

A further embodiment of any of the foregoing embodiments of the present disclosure includes integrally manufacturing a multiple of cooling holes through the liner panel.

A further embodiment of any of the foregoing embodiments of the present disclosure includes integrally manufacturing a stud with the liner panel.

The foregoing features and elements may be combined in various combinations without exclusivity, unless expressly indicated otherwise. These features and elements as well as the operation of the invention will become more apparent in light of the following description and the accompanying drawings. It should be understood, however, the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic cross-section of a gas turbine engine;

FIG. 2 is an expanded longitudinal schematic sectional view of a combustor section according to one non-limiting embodiment that may be used with the gas turbine engine shown in FIG. 1;

FIG. 3 is an expanded longitudinal schematic partial perspective view of a combustor section according to one non-limiting embodiment that may be used with the gas turbine engine shown in FIG. 1;

FIG. 4 is an expanded perspective view of a liner panel array from a cold side;

FIG. 5 is an exploded view of a wall assembly of the combustor; and

FIG. 6 is an expanded circumferentially partial perspective view of the combustor section.

### DETAILED DESCRIPTION

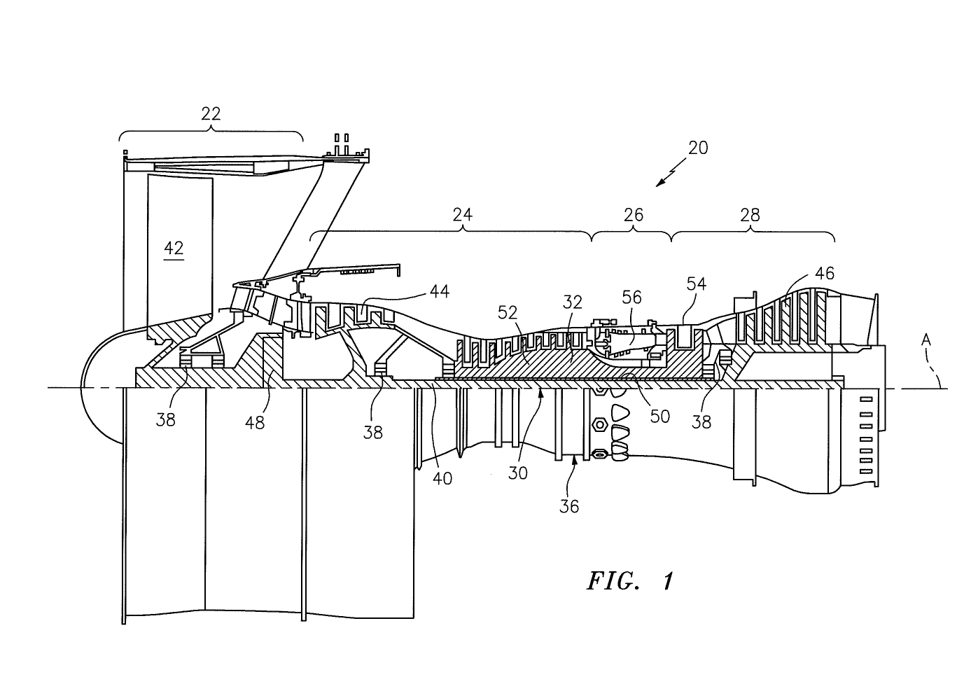

FIG. 1 schematically illustrates a gas turbine engine 20. The gas turbine engine 20 is disclosed herein as a two-spool turbo fan that generally incorporates a fan section 22, a compressor section 24, a combustor section 26 and a turbine section 28. Alternative engines might include an augmentor section (not shown) among other systems or features. The fan section 22 drives air along a bypass flowpath while the compressor section 24 drives air along a core flowpath for compression and communication into the combustor section 26 then expansion through the turbine section 28. Although depicted as a turbofan in the disclosed non-limiting embodiment, it should be understood that the concepts described herein are not limited to use with turbofans as the teachings may be applied to other types of turbine engines such as a turbojets, turboshafts, and three-spool (plus fan) turbofans wherein an intermediate spool includes an intermediate pressure compressor (“IPC”) between a Low Pressure Compressor (“LPC”) and a High Pressure Compressor (“HPC”), and an intermediate pressure turbine (“IPT”) between the high pressure turbine (“HPT”) and the Low pressure Turbine (“LPT”).

The engine 20 generally includes a low spool 30 and a high spool 32 mounted for rotation about an engine central longitudinal axis A relative to an engine static structure 36 via several bearing structures 38. The low spool 30 generally includes an inner shaft 40 that interconnects a fan 42, a low pressure compressor (“LPC”) 44 and a low pressure turbine (“LPT”) 46. The inner shaft 40 drives the fan 42 directly or through a geared architecture 48 to drive the fan 42 at a lower speed than the low spool 30. An exemplary reduction transmission is an epicyclic transmission, namely a planetary or star gear system.

The high spool 32 includes an outer shaft 50 that interconnects a high pressure compressor (“HPC”) 52 and high pressure turbine (“HPT”) 54. A combustor 56 is arranged between the high pressure compressor 52 and the high pressure turbine 54. The inner shaft 40 and the outer shaft 50 are concentric and rotate about the engine central longitudinal axis A which is collinear with their longitudinal axes.

Core airflow is compressed by the LPC 44 then the HPC 52, mixed with the fuel and burned in the combustor 56, then expanded over the HPT 54 and the LPT 46. The turbines 54, 46 rotationally drive the respective low spool 30 and high spool 32 in response to the expansion. The main engine shafts 40, 50 are supported at a plurality of points by bearing structures 38 within the static structure 36. It should be understood that various bearing structures 38 at various locations may alternatively or additionally be provided.

In one non-limiting example, the gas turbine engine 20 is a high-bypass geared aircraft engine. In a further example, the gas turbine engine 20 bypass ratio is greater than about six (6:1). The geared architecture 48 can include an epicyclic gear train, such as a planetary gear system or other gear system. The example epicyclic gear train has a gear reduction ratio of greater than about 2.3, and in another example is greater than about 2.5:1. The geared turbofan enables operation of the low spool 30 at higher speeds which can increase the operational efficiency of the LPC 44 and LPT 46 and render increased pressure in a fewer number of stages.

A pressure ratio associated with the LPT 46 is pressure measured prior to the inlet of the LPT 46 as related to the pressure at the outlet of the LPT 46 prior to an exhaust nozzle of the gas turbine engine 20. In one non-limiting embodiment, the bypass ratio of the gas turbine engine 20 is greater than about ten (10:1), the fan diameter is significantly larger than that of the LPC 44, and the LPT 46 has a pressure ratio that is greater than about five (5:1). It should be understood, however, that the above parameters are only exemplary of one embodiment of a geared architecture engine and that the present disclosure is applicable to other gas turbine engines including direct drive turbofans.

In one embodiment, a significant amount of thrust is provided by the bypass flow path due to the high bypass ratio. The fan section 22 of the gas turbine engine 20 is designed for a particular flight condition—typically cruise at about 0.8 Mach and about 35,000 feet. This flight condition, with the gas turbine engine 20 at its best fuel consumption, is also known as bucket cruise Thrust Specific Fuel Consumption (TSFC). TSFC is an industry standard parameter of fuel consumption per unit of thrust.

Fan Pressure Ratio is the pressure ratio across a blade of the fan section 22 without the use of a Fan Exit Guide Vane system. The low Fan Pressure Ratio according to one non-limiting embodiment of the example gas turbine engine 20 is less than 1.45. Low

Corrected Fan Tip Speed is the actual fan tip speed divided by an industry standard temperature correction of (“Tram”/518.7)^{0.5}. The Low Corrected Fan Tip Speed according to one non-limiting embodiment of the example gas turbine engine 20 is less than about 1150 fps (351 m/s).

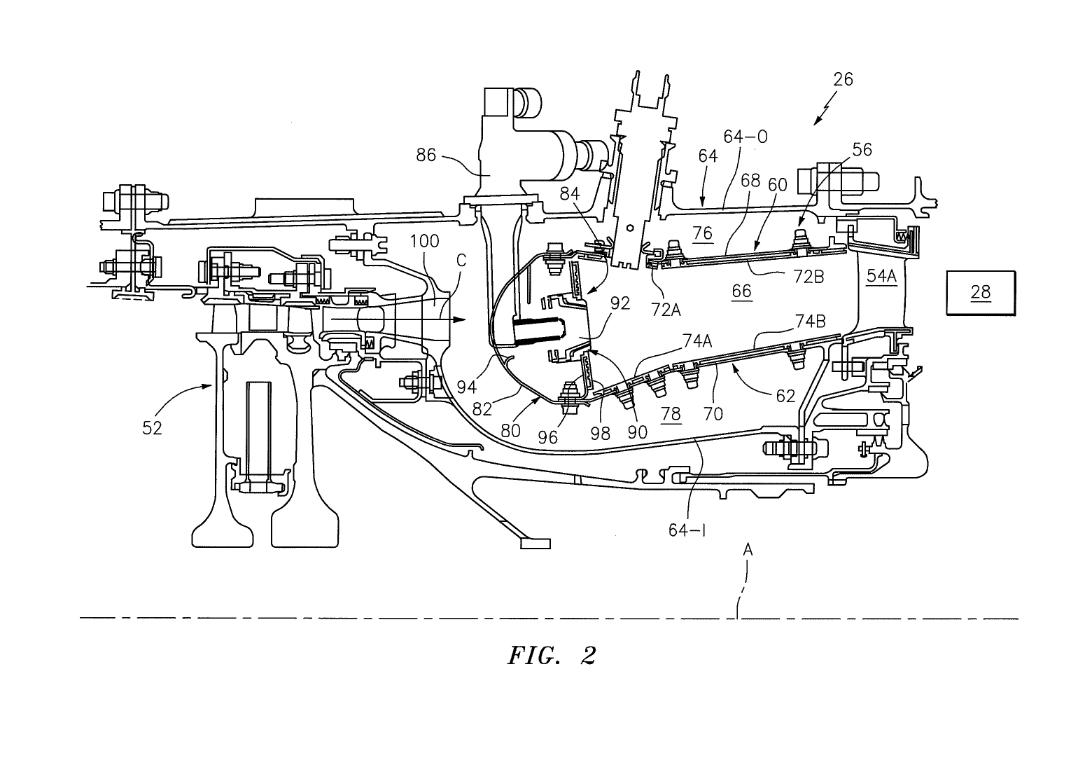

With reference to FIG. 2, the combustor 56 generally includes an outer combustor wall assembly 60, an inner combustor wall assembly 62 and a diffuser case module 64. The outer combustor wall assembly 60 and the inner combustor wall assembly 62 are spaced apart such that a combustion chamber 66 is defined therebetween. The combustion chamber 66 is generally annular in shape.

The outer combustor wall assembly 60 is spaced radially inward from an outer diffuser case 64-O of the diffuser case module 64 to define an outer annular plenum 76. The inner combustor wall assembly 62 is spaced radially outward from an inner diffuser case 64-I of the diffuser case module 64 to define an inner annular plenum 78. It should be understood that although a particular combustor is illustrated, other combustor types with various combustor liner arrangements will also benefit herefrom. It should be further understood that the disclosed cooling flow paths are but an illustrated embodiment and should not be limited only thereto.

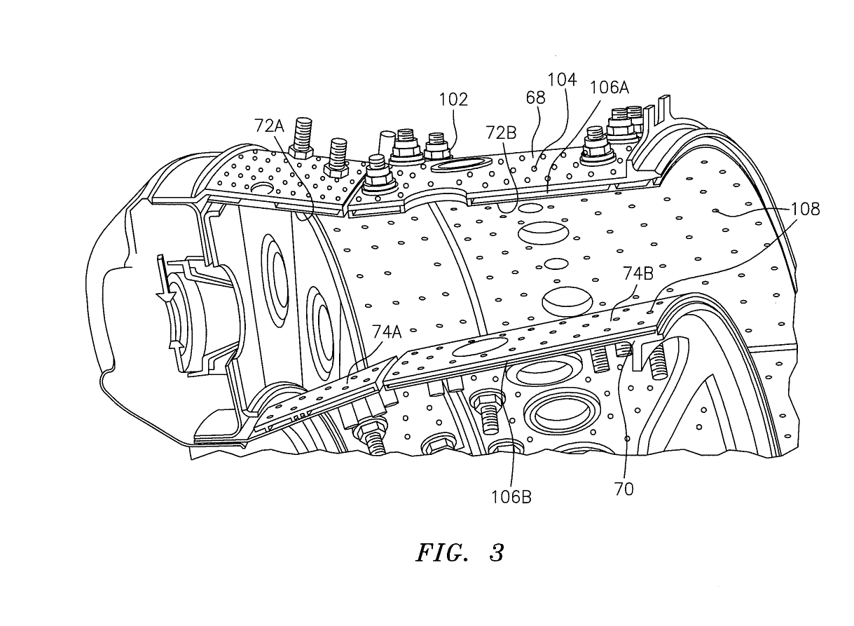

The combustor liner assemblies 60, 62 contain the combustion products for direction toward the turbine section 28. Each combustor wall assembly 60, 62 generally includes a respective support shell 68, 70 which supports one or more liner panels 72, 74 mounted to a hot side of the respective support shell 68, 70. Each of the liner panels 72, 74 may be generally rectilinear and manufactured of, for example, a nickel based super alloy, ceramic or other temperature resistant material and are arranged to form a liner array. In one disclosed non-limiting embodiment, the liner array includes a multiple of forward liner panels 72A and a multiple of aft liner panels 72B that are circumferentially staggered to line the hot side of the outer shell 68 (also shown in FIG. 3). A multiple of forward liner panels 74A and a multiple of aft liner panels 74B are circumferentially staggered to line the hot side of the inner shell 70 (also shown in FIG. 3).

The combustor 56 further includes a forward assembly 80 immediately downstream of the compressor section 24 to receive compressed airflow therefrom. The forward assembly 80 generally includes an annular hood 82, a bulkhead assembly 84, a multiple of fuel nozzles 86 (one shown) and a multiple of fuel nozzle guides 90 (one shown).

Each of the fuel nozzle guides 90 is circumferentially aligned with one of the hood ports 94 to project through the bulkhead assembly 84. Each bulkhead assembly 84 includes a bulkhead support shell 96 secured to the combustor liner assemblies 60, 62, and a multiple of circumferentially distributed bulkhead liner panels 98 secured to the bulkhead support shell 96 around the central opening 92.

The annular hood 82 extends radially between, and is secured to, the forwardmost ends of the combustor liner assemblies 60, 62. The annular hood 82 includes a multiple of circumferentially distributed hood ports 94 that accommodate the respective fuel nozzle 86 and introduce air into the forward end of the combustion chamber 66 through a central opening 92. Each fuel nozzle 86 may be secured to the diffuser case module 64 and project through one of the hood ports 94 and through the central opening 92 within the respective fuel nozzle guide 90.

The forward assembly 80 introduces core combustion air into the forward section of the combustion chamber 66 while the remainder enters the outer annular plenum 76 and the inner annular plenum 78. The multiple of fuel nozzles 86 and adjacent structure generate a blended fuel-air mixture that supports stable combustion in the combustion chamber 66.

Opposite the forward assembly 80, the outer and inner support shells 68, 70 are mounted to a first row of Nozzle Guide Vanes (NGVs) 54A in the HPT 54. The NGVs 54A are static engine components which direct core airflow combustion gases onto the turbine blades of the first turbine rotor in the turbine section 28 to facilitate the conversion of pressure energy into kinetic energy. The core airflow combustion gases are also accelerated by the

NGVs 54A because of their convergent shape and are typically given a “spin” or a “swirl” in the direction of turbine rotor rotation. The turbine rotor blades absorb this energy to drive the turbine rotor at high speed.

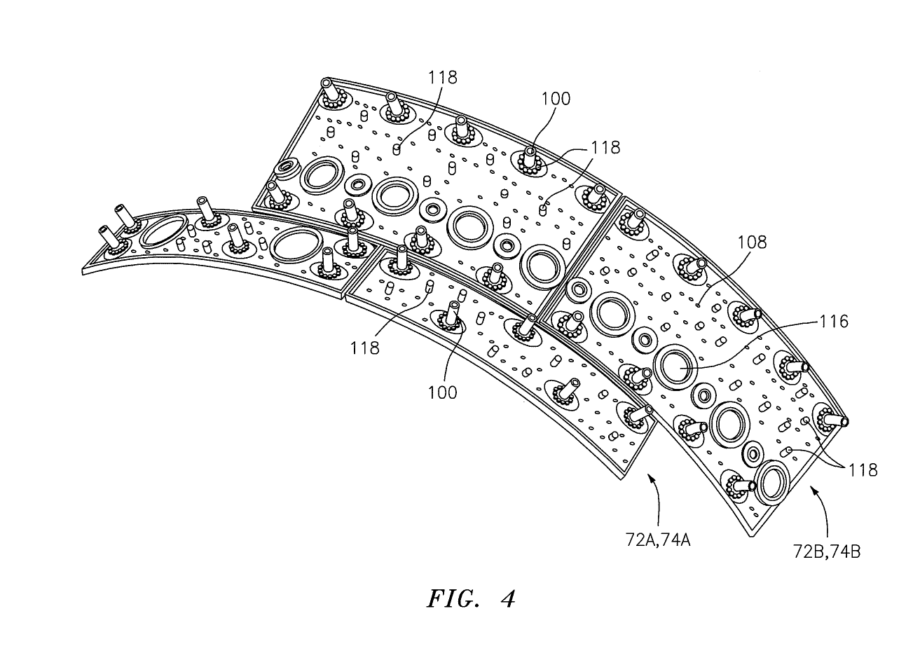

With reference to FIG. 4, a multiple of studs 100 extend from the liner panels 72, 74 so as to permit the liner panels 72, 74 to be mounted to their respective support shells 68, 70 with fasteners 102 such as nuts (shown in FIG. 3). That is, the studs 100 project rigidly from the liner panels 72, 74 and through the respective support shells 68, 70 to receive the fasteners 102 at a threaded distal end section thereof.

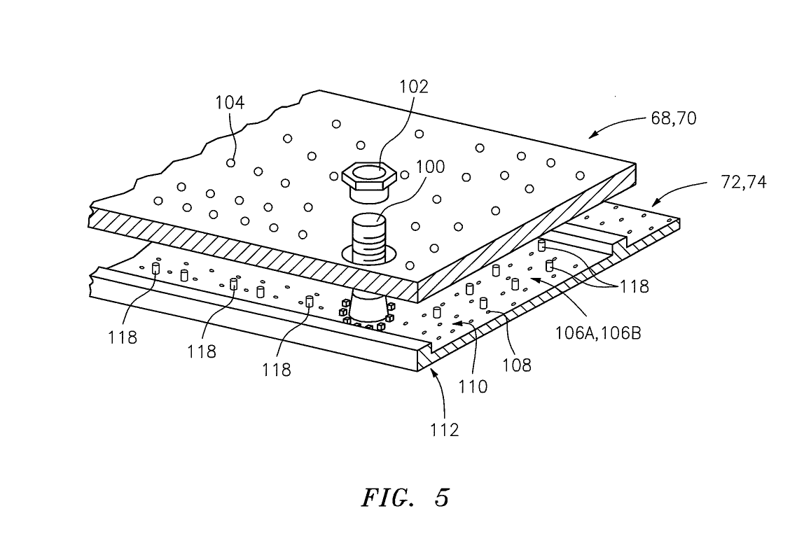

A multiple of cooling impingement holes 104 penetrate through the support shells 68, 70 to allow air from the respective annular plenums 76, 78 to enter cavities 106A, 106B (also shown in FIG. 5) formed in the combustor liner assemblies 60, 62 between the respective support shells 68, 70 and liner panels 72, 74. The cooling impingement holes 104 are generally normal to the surface of the liner panels 72, 74. The air in the cavities 106A, 106B provides backside impingement cooling of the liner panels 72, 74 that is generally defined herein as heat removal via internal convection.

A multiple of cooling film holes 108 penetrate through each of the liner panels 72, 74. The geometry of the film holes, e.g, diameter, shape, density, surface angle, incidence angle, etc., as well as the location of the holes with respect to the high temperature main flow also contributes to effusion film cooling. The combination of impingement holes 104 and film holes 108 may be referred to as an Impingement Film Floatwall assembly.

The cooling film holes 108 allow the air to pass from the cavities 106A, 106B defined in part by a cold side 110 of the liner panels 72, 74 to a hot side 112 of the liner panels 72, 74 and thereby facilitate the formation of a film of cooling air along the hot side 112. The cooling film holes 108 are generally more numerous than the impingement holes 104 to promote the development of a film cooling along the hot side 112 to sheath the liner panels 72, 74 Film cooling as defined herein is the introduction of a relatively cooler airflow at one or more discrete locations along a surface exposed to a high temperature environment to protect that surface in the immediate region of the airflow injection as well as downstream thereof.

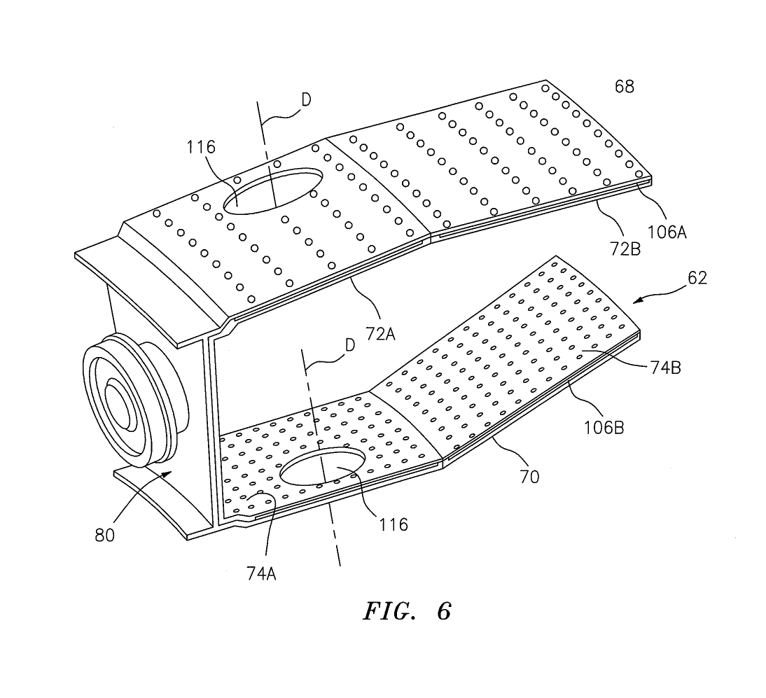

A multiple of dilution holes 116 penetrate through both the respective support shells 68, 70 and liner panels 72, 74 along a common axis D (FIG. 6). For example only, in a Rich-Quench-Lean (R-Q-L) type combustor, the dilution holes 116 are located downstream of the forward assembly 80 to quench the hot gases by supplying cooling air into the combustor. The hot combustion gases slow towards the dilution holes 116 and may form a stagnation point at the leading edge which becomes a heat source and may challenge the durability of the liner panels 72, 74 proximate this location. At the trailing edge of the dilution hole, due to interaction with dilution jet, hot gases form a standing vortex pair that may also challenge the durability of the liner panels 72, 74 proximate this location.

With continued reference to FIG. 4, a multiple of heat transfer augmentation feature 118 extends from the cold side 110 of each liner panel 72, 74. Various heights, widths and lengths of heat transfer augmentation features 118 may be utilized. Furthermore, various distributions and combination of the heat transfer augmentation features 118 may be utilized in either or both the circumferential or spanwise direction.

The support shells 68, 70 and liner panels 72, 74 are manufactured via an additive manufacturing process the beneficially permits ready incorporation of the relatively small heat transfer augmentation features 118 as well as the cooling impingement holes 104, the cooling film holes 108 and/or dilution holes 116 during manufacture. One additive manufacturing process includes powder bed metallurgy in which layers of powder alloy such as nickel, cobalt, or other material is sequentially build-up by systems from, for example,

Concept Laser of Lichtenfels, DE and EOS of Munich, DE, e.g. direct metal laser sintering or electron beam melting.

The heat transfer augmentation features 118, be they pins, cylinders, pyramids, rectangular and/or other geometries, as well as the holes 104, 108, 116 are thereby embedded in or inherent to the layered metal fabrication process and product that is produced.

In other words, the aforementioned techniques have the “print resolution” to melt, sinter or weld the powered metal in specific area and at target dimensions to provide the requisite heat transfer augmentation features 118. These techniques have layer resolution on the order of 20-50 microns which in adequate to generate well-defined shapes on the order of 0.020-0.100 required to have benefits as heat transfer augmentation features 118. Direct Metal Laser Sintering (DMLS) is a free form fabrication, powder-bed manufacturing process. Hardware is built up in a layer-by-layer fashion with a process that starts by slicing a CAD file into 20 μm (0.8 mils) or larger thick layers. This altered CAD file is loaded into the DMLS machine which builds the hardware one layer at a time, as defined by the new CAD file. Electron beam melting (EBM) is a powder bed additive manufacturing process. EBM, however, uses an electron beam to melt powdered metal deposited layer by layer in a vacuum to build up three dimensional parts. A CAD file is sliced into 50 μm or 70 μm (2.0 mils or 2.8 mils) thick layers, stored as STL files, which are then loaded into the EBM machine. An electron beam is created by running a current through a tungsten filament, then creating a potential across it to rip off the electrons. The electrons are steered and focused to the build plate by magnetic fields. The lack of moving parts allows for very fast scanning speeds up to 8000 m/s.

Such additively manufactured support shells 68, 70 and liner panels 72, 74 also provide a strength that is greater than about seventy percent (70%) that of its wrought material. This compares to conventional similar components that are cast and have a strength that is less than about seventy percent (70%) that of its wrought material.

Such additively manufactured support shells 68, 70 and liner panels 72, 74 also permit the holes 104, 108, 116 to be integrally formed which eliminates a post process drill operation and its attendant possibility of deformation and strength loss. Such additively manufactured support shells 68, 70 and liner panels 72, 74 also permit the studs 100 to be integrally formed which still further streamlines manufacture.

The use of the terms “a” and “an” and “the” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other. It should be appreciated that relative positional terms such as “forward,” “aft,” “upper,” “lower,” “above,” “below,” and the like are with reference to the normal operational attitude of the vehicle and should not be considered otherwise limiting.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be appreciated that like reference numerals identify corresponding or similar elements throughout the several drawings. It should also be appreciated that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

What is claimed is:

1. A combustor of a gas turbine engine comprising:
an additively manufactured liner panel.

2. The combustor as recited in claim 1, wherein said additively manufactured liner panel includes a heat transfer augmentation feature.

3. The combustor as recited in claim 2, wherein said additively manufactured liner panel heat transfer augmentation feature is a ramp.

4. The combustor as recited in claim 2, wherein said heat transfer augmentation feature is rectilinear.

5. The combustor as recited in claim 2, wherein said heat transfer augmentation feature is arcuate.

6. The combustor as recited in claim 2, wherein said heat transfer augmentation feature is a pin.

7. The combustor as recited in claim 1, wherein said additively manufactured liner panel includes at least one hole.

8. The combustor as recited in claim 7, wherein said at least one hole is a cooling hole.

9. The combustor as recited in claim 7, wherein said at least one hole is a film cooling hole.

10. The combustor as recited in claim 7, wherein said at least one cooling hole is a dilution hole.

11. A combustor of a gas turbine engine comprising:
a liner panel with one or more heat transfer augmentation features, said liner panel having a strength greater than about seventy percent (70%) that of its wrought material.

12. The liner panel as recited in claim 11, wherein said liner panel is additive manufactured.

13. The combustor as recited in claim 11, further comprising a plurality of studs which extend from a cold side of said additively manufactured liner panel.

14. The combustor as recited in claim 11, wherein said additively manufactured liner panel includes at least one hole.

15. A method of manufacturing a liner panel of a combustor of a gas turbine engine, comprising:
additively manufacturing a liner panel with a heat transfer augmentation feature.

16. The method as recited in claim 15, further comprising:
integrally manufacturing a hole through the liner panel.

17. The method as recited in claim 15, further comprising:
integrally manufacturing a multiple of cooling holes through the liner panel.

18. The method as recited in claim 15, further comprising:
integrally manufacturing a stud with the liner panel.
